(19) United States
(12) Patent Application Publication
(10) Pub. No.: US 2024/0331115 A1
(43) Pub. Date: Oct. 3, 2024

(54) IMAGE DISTORTION CORRECTION IN CHARGED PARTICLE INSPECTION

(71) Applicant: ASML Netherlands B.V., Veldhoven (NL)

(72) Inventors: Haoyi LIANG, Sunnyvale, CA (US); Zhichao CHEN, San Jose, CA (US); Lingling PU, San Jose, CA (US); Fang-Cheng CHANG, Los Altos, CA (US); Liangjiang YU, Pleasanton, CA (US); Zhe WANG, Dublin, CA (US)

(73) Assignee: ASML Netherlands B.V., Veldhoven (NL)

(21) Appl. No.: 18/577,678

(22) PCT Filed: Jun. 2, 2022
(86) PCT No.: PCT/EP2022/065032

§ 371 Date: Jan. 8, 2024

Related U.S. Application Data
(60) Provisional application No. 63/220,370, filed on Jul. 9, 2021.

(51) Int. Cl. G06T 5/80; G06T 7/00; G06T 7/33

(52) U.S. Cl. CPC G06T 5/80; G06T 7/001; G06T 7/337; G06T 2207/10061; G06T 2207/20081; G06T 2207/30148

(57) ABSTRACT

An improved systems and methods for correcting distortion of an inspection image are disclosed. An improved method for correcting distortion of an inspection image comprises acquiring an inspection image, aligning a plurality of patches of the inspection image based on a reference image corresponding to the inspection image, evaluating, by a machine learning model, alignments between each patch of the plurality of patches and a corresponding patch of the reference image, determining local alignment results for the plurality of patches of the inspection image based on a reference image corresponding to the inspection image, determining an alignment model based on the local alignment results, and correcting a distortion of the inspection image based on the alignment model.

### CROSS-REFERENCE TO RELATED APPLICATIONS

This application claims priority of U.S. application 63/220,370 which was filed on 9 Jul. 2021 and which is incorporated herein in its entirety by reference.

### TECHNICAL FIELD

The embodiments provided herein relate to an image enhancement technology, and more particularly to a distortion correction mechanism for a charged-particle beam inspection image.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, accuracy and yield in defect detection become more important. Inspection images such as SEM images can be used to identify or classify a defect(s) of the manufactured ICs. To improve defect detection performance, obtaining an accurate SEM image without distortion nor misalignment is desired.

### SUMMARY

The embodiments provided herein disclose a particle beam inspection apparatus, and more particularly, an inspection apparatus using a plurality of charged particle beams.

In some embodiments, a method for correcting distortion of an inspection image is provided. The method comprises acquiring an inspection image, determining local alignment results for a plurality of patches of the inspection image based on a reference image corresponding to the inspection image; for each subset of a plurality of subsets of the local alignment results: determining an alignment model based on the subset of the local alignment results, and evaluating the alignment model based on a fit of the alignment model to a remainder set of the local alignment results; selecting one alignment model among the plurality of alignment models based on the evaluations; and correcting a distortion of the inspection image based on the selected alignment model.

In some embodiments, an apparatus for correcting distortion of an inspection image is provided. The apparatus comprises a memory storing a set of instructions; and at least one processor configured to execute the set of instructions to cause the apparatus to perform: acquiring an inspection image; determining local alignment results for a plurality of patches of the inspection image based on a reference image corresponding to the inspection image; for each subset of a plurality of subsets of the local alignment results: determining an alignment model based on the subset of the local alignment results, and evaluating the alignment model based on a fit of the alignment model to a remainder set of the local alignment results; selecting one alignment model among the plurality of alignment models based on the evaluations; and correcting a distortion of the inspection image based on the selected alignment model.

In some embodiments, a non-transitory computer readable medium that stores a set of instructions that is executable by at least on processor of a computing device to cause the computing device to perform a method for correcting distortion of an inspection image is provided. The method comprises acquiring an inspection image, determining local alignment results for a plurality of patches of the inspection image based on a reference image corresponding to the inspection image; for each subset of a plurality of subsets of the local alignment results: determining an alignment model based on the subset of the local alignment results, and evaluating the alignment model based on a fit of the alignment model to a remainder set of the local alignment results; selecting one alignment model among the plurality of alignment models based on the evaluations; and correcting a distortion of the inspection image based on the selected alignment model.

In some embodiments, a method for correcting distortion of an inspection image is provided. The method comprises: acquiring an inspection image; determining local alignment results for a plurality of patches of the inspection image based on a reference image corresponding to the inspection image; estimating a first alignment model based on a first subset of the local alignment results and estimating a second alignment model based on a second subset of the local alignment results; evaluating the first alignment model based on a fit of the first alignment model to a first remainder set of the local alignment results and evaluating the second alignment model based on a fit of the second alignment model to a second remainder set of the local alignment results; selecting one of the first alignment model and the second alignment model based on the evaluations; and correcting a distortion of the inspection image based on the selected alignment model.

In some embodiments, an apparatus for correcting distortion of an inspection image is provided. The apparatus comprises: a memory storing a set of instructions; and at least one processor configured to execute the set of instructions to cause the apparatus to perform: acquiring an inspection image; determining local alignment results for a plurality of patches of the inspection image based on a reference image corresponding to the inspection image; estimating a first alignment model based on a first subset of the local alignment results and estimating a second alignment model based on a second subset of the local alignment results; evaluating the first alignment model based on a fit of the first alignment model to a first remainder set of the local alignment results and evaluating the second alignment model based on a fit of the second alignment model to a second remainder set of the local alignment results; selecting one of the first alignment model and the second alignment model based on the evaluations; and correcting a distortion of the inspection image based on the selected alignment model.

In some embodiments, a non-transitory computer readable medium that stores a set of instructions that is executable by at least on processor of a computing device to cause the computing device to perform a method for correcting distortion of an inspection image is provided. The method comprises: acquiring an inspection image; determining local alignment results for a plurality of patches of the inspection image based on a reference image corresponding to the inspection image; estimating a first alignment model based on a first subset of the local alignment results and estimating a second alignment model based on a second subset of the local alignment results; evaluating the first alignment model based on a fit of the first alignment model to a first remainder set of the local alignment results and evaluating the second alignment model based on a fit of the second alignment model to a second remainder set of the local alignment results; selecting one of the first alignment model and the second alignment model based on the evaluations; and correcting a distortion of the inspection image based on the selected alignment model.

In some embodiments, a method for correcting distortion of an inspection image is provided. The method comprises: acquiring an inspection image; aligning a plurality of patches of the inspection image based on a reference image corresponding to the inspection image; evaluating, by a machine learning model, alignments between each patch of the plurality of patches and a corresponding patch of the reference image; determining local alignment results for the plurality of patches of the inspection image based on a reference image corresponding to the inspection image; determining an alignment model based on the local alignment results; and correcting a distortion of the inspection image based on the alignment model.

In some embodiments, an apparatus for correcting distortion of an inspection image is provided. The apparatus comprises: a memory storing a set of instructions; and at least one processor configured to execute the set of instructions to cause the apparatus to perform: acquiring an inspection image; aligning a plurality of patches of the inspection image based on a reference image corresponding to the inspection image; evaluating, by a machine learning model, alignments between each patch of the plurality of patches and a corresponding patch of the reference image; determining local alignment results for the plurality of patches of the inspection image based on a reference image corresponding to the inspection image; determining an alignment model based on the local alignment results; and correcting a distortion of the inspection image based on the alignment model.

In some embodiments, a non-transitory computer readable medium that stores a set of instructions that is executable by at least on processor of a computing device to cause the computing device to perform a method for correcting distortion of an inspection image is provided. The method comprises: acquiring an inspection image; determining local alignment results for a plurality of patches of the inspection image based on a reference image corresponding to the inspection image; estimating a first alignment model based on a first subset of the local alignment results and estimating a second alignment model based on a second subset of the local alignment results; evaluating the first alignment model based on a fit of the first alignment model to a first remainder set of the local alignment results and evaluating the second alignment model based on a fit of the second alignment model to a second remainder set of the local alignment results; selecting one of the first alignment model and the second alignment model based on the evaluations; and correcting a distortion of the inspection image based on the selected alignment model.

In some embodiments, a method of evaluating alignment of an inspection image and a reference image is provided. The method comprises acquiring a plurality of patches of the inspection image and a plurality of reference patches of the reference image, the plurality of patches corresponding to the plurality of reference patches; and evaluating, by a machine learning model, an alignment of the plurality of patches and the plurality of reference patches.

In some embodiments, an apparatus of evaluating alignment of an inspection image and a reference image is provided. The apparatus comprises a memory storing a set of instructions; and at least one processor configured to execute the set of instructions to cause the apparatus to perform: acquiring a plurality of patches of the inspection image and a plurality of reference patches of the reference image, the plurality of patches corresponding to the plurality of reference patches; and evaluating, by a machine learning model, an alignment of the plurality of patches and the plurality of reference patches.

In some embodiments, a non-transitory computer readable medium that stores a set of instructions that is executable by at least on processor of a computing device to cause the computing device to perform a method of evaluating alignment of an inspection image and a reference image. The method comprises acquiring a plurality of patches of the inspection image and a plurality of reference patches of the reference image, the plurality of patches corresponding to the plurality of reference patches; and evaluating, by a machine learning model, an alignment of the plurality of patches and the plurality of reference patches.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF FIGURES

The above and other aspects of the present disclosure will become more apparent from the description of exemplary embodiments, taken in conjunction with the accompanying drawings.

FIG. 1 is a schematic diagram illustrating an example charged-particle beam inspection system, consistent with embodiments of the present disclosure.

FIG. 2 is a schematic diagram illustrating an example multi-beam tool that can be a part of the example charged-particle beam inspection system of FIG. 1, consistent with embodiments of the present disclosure.

FIG. 3 illustrates a SEM image with example patterns that may cause a local misalignment.

FIG. 4 is a block diagram of an example distortion correction system, consistent with embodiments of the present disclosure.

FIG. 5A illustrates an example inspection image that are segmented into a plurality of patches, consistent with embodiments of the present disclosure.

FIG. 5B is an example graph illustrating local alignment results, consistent with embodiments of the present disclosure.

FIG. 5C is an example graph illustrating an alignment model, consistent with embodiments of the present disclosure.

FIG. 6A illustrates an example process correcting distortions of a SEM image according to local alignment results.

FIG. 6B illustrates an example process correcting distortions of a SEM image according to an alignment model consistent with embodiments of the present disclosure.

FIG. 6C illustrates an example comparison between an input image and an output image after a distortion correction consistent with embodiments of the present disclosure.

FIG. 7A illustrates an example inspection image with shifted repetitive patterns.

FIG. 7B is a block diagram of a training system for an alignment evaluation model, consistent with embodiments of the present disclosure.

FIG. 8A illustrates example training data sets for a training system of FIG. 7B, consistent with embodiments of the present disclosure.

FIG. 8B illustrates an example configuration of an alignment evaluation model, consistent with embodiments of the present disclosure.

FIG. 9 is a process flowchart representing an exemplary method for correcting a distortion of an inspection image, consistent with embodiments of the present disclosure.

FIG. 10 is a process flowchart representing an exemplary method for training an alignment evaluation model, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged particle beams may be similarly applied. Furthermore, other imaging systems may be used, such as optical imaging, photo detection, x-ray detection, etc.

Electronic devices are constructed of circuits formed on a piece of semiconductor material called a substrate. The semiconductor material may include, for example, silicon, gallium arsenide, indium phosphide, or silicon germanium, or the like. Many circuits may be formed together on the same piece of silicon and are called integrated circuits or ICs. The size of these circuits has decreased dramatically so that many more of them can be fit on the substrate. For example, an IC chip in a smartphone can be as small as a thumbnail and yet may include over 2 billion transistors, the size of each transistor being less than 1/1000th the size of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process; that is, to improve the overall yield of the process.

One component of improving yield is monitoring the chip-making process to ensure that it is producing a sufficient number of functional integrated circuits. One way to monitor the process is to inspect the chip circuit structures at various stages of their formation. Inspection can be carried out using a scanning charged-particle microscope (SCPM). For example, an SCPM may be a scanning electron microscope (SEM). A SCPM can be used to image these extremely small structures, in effect, taking a “picture” of the structures of the wafer. The image can be used to determine if the structure was formed properly in the proper location. If the structure is defective, then the process can be adjusted. so the defect is less likely to recur.

As the physical sizes of IC components continue to shrink, accuracy and yield in defect detection become more important. Inspection images such as SEM images can be used to identify or classify a defect(s) of the manufactured ICs. To improve defect detection performance, obtaining an accurate SEM image without distortion nor misalignment is desired. While various distortion correction techniques for SEM images have been introduced, many of them rely on local alignments of smaller patches of the SEM image. Although a distortion amount in each patch is smaller than that in an entire SEM image, a local alignment can be challenging due to various reasons comprising, but not limited to, sparse or repeating patterns, unsatisfactory imaging conditions, lack of pattern information, residual distortion, etc. Because in current approaches a distortion correction of an SEM image is highly dependent on performance of local alignments of smaller patches of the SEM image, errored or imperfect local alignments can deteriorate distortion correction performance for an SEM image.

Embodiments of the disclosure may provide a distortion correction technique for SEM images. According to some embodiments of the present disclosure, potential flawed or contaminated data in local alignment results can be acknowledged and influence thereof can be minimized when correcting distortions of an SEM image. Embodiments of the disclosure can provide a machine learning based alignment evaluation algorithm that can reliably evaluate whether an SEM image is well aligned to a reference image. According to some embodiments of the present disclosure, a machine learning based alignment evaluation algorithm can be trained with a pair of a SEM image clip and a reference image clip.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C. or A and B and C.

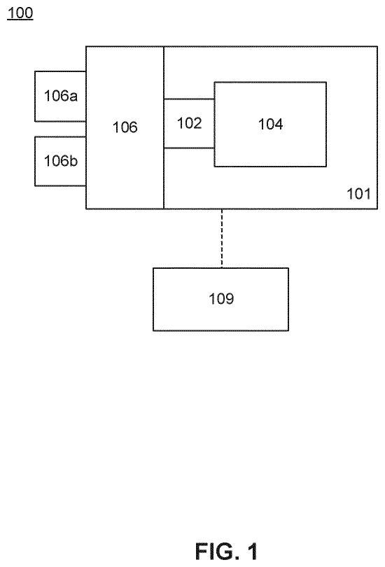

FIG. 1 illustrates an example electron beam inspection (EBI) system 100 consistent with embodiments of the present disclosure. EBI system 100 may be used for imaging. As shown in FIG. 1. EBI system 100 includes a main chamber 101, a load/lock chamber 102, a beam tool 104, and an equipment front end module (EFEM) 106. Beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by beam tool 104. Beam tool 104 may be a single-beam system or a multi-beam system.

A controller 109 is electronically connected to beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (or “apps”) for specific tasks. The memory may also be a virtual memory that includes one or more memories distributed across multiple machines or devices coupled via a network.

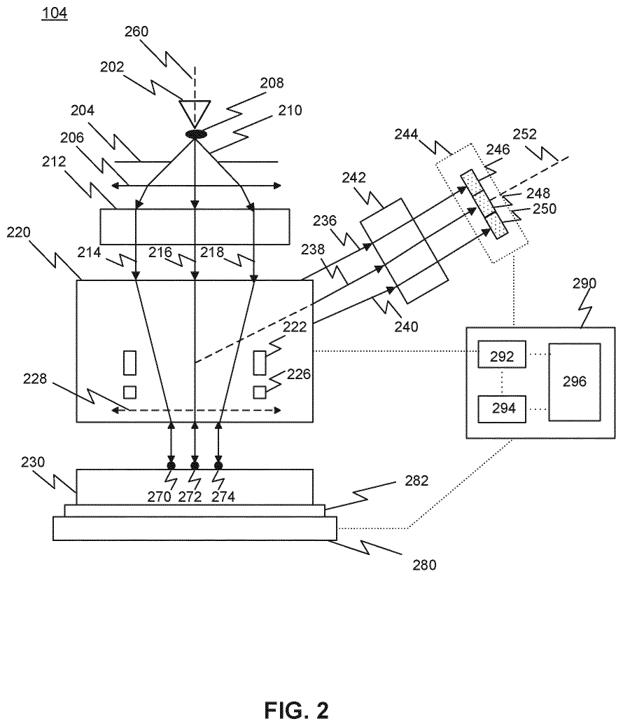

FIG. 2 illustrates a schematic diagram of an example multi-beam tool 104 (also referred to herein as apparatus 104) and an image processing system 290 that may be configured for use in EBI system 100 (FIG. 1), consistent with embodiments of the present disclosure.

Beam tool 104 comprises a charged-particle source 202, a gun aperture 204, a condenser lens 206, a primary charged-particle beam 210 emitted from charged-particle source 202, a source conversion unit 212, a plurality of beamlets 214, 216, and 218 of primary charged-particle beam 210, a primary projection optical system 220, a motorized wafer stage 280, a wafer holder 282, multiple secondary charged-particle beams 236, 238, and 240, a secondary optical system 242, and a charged-particle detection device 244. Primary projection optical system 220 can comprise a beam separator 222, a deflection scanning unit 226, and an objective lens 228. Charged-particle detection device 244 can comprise detection sub-regions 246, 248, and 250.

Charged-particle source 202, gun aperture 204, condenser lens 206, source conversion unit 212, beam separator 222, deflection scanning unit 226, and objective lens 228 can be aligned with a primary optical axis 260 of apparatus 104. Secondary optical system 242 and charged-particle detection device 244 can be aligned with a secondary optical axis 252 of apparatus 104.

Charged-particle source 202 can emit one or more charged particles, such as electrons, protons, ions, muons, or any other particle carrying electric charges. In some embodiments, charged-particle source 202 may be an electron source. For example, charged-particle source 202 may include a cathode, an extractor, or an anode, wherein primary electrons can be emitted from the cathode and extracted or accelerated to form primary charged-particle beam 210 (in this case, a primary electron beam) with a crossover (virtual or real) 208. For ease of explanation without causing ambiguity, electrons are used as examples in some of the descriptions herein. However, it should be noted that any charged particle may be used in any embodiment of this disclosure, not limited to electrons. Primary charged-particle beam 210 can be visualized as being emitted from crossover 208. Gun aperture 204 can block off peripheral charged particles of primary charged-particle beam 210 to reduce Coulomb effect. The Coulomb effect may cause an increase in size of probe spots.

Source conversion unit 212 can comprise an array of image-forming elements and an array of beam-limit apertures. The array of image-forming elements can comprise an array of micro-deflectors or micro-lenses. The array of image-forming elements can form a plurality of parallel images (virtual or real) of crossover 208 with a plurality of beamlets 214, 216, and 218 of primary charged-particle beam 210. The array of beam-limit apertures can limit the plurality of beamlets 214, 216, and 218. While three beamlets 214, 216, and 218 are shown in FIG. 2, embodiments of the present disclosure are not so limited. For example, in some embodiments, the apparatus 104 may be configured to generate a first number of beamlets. In some embodiments, the first number of beamlets may be in a range from 1 to 1000. In some embodiments, the first number of beamlets may be in a range from 200-500. In an exemplary embodiment, an apparatus 104 may generate 400 beamlets.

Condenser lens 206 can focus primary charged-particle beam 210. The electric currents of beamlets 214, 216, and 218 downstream of source conversion unit 212 can be varied by adjusting the focusing power of condenser lens 206 or by changing the radial sizes of the corresponding beam-limit apertures within the array of beam-limit apertures. Objective lens 228 can focus beamlets 214, 216, and 218 onto a wafer 230 for imaging, and can form a plurality of probe spots 270, 272, and 274 on a surface of wafer 230.

Beam separator 222 can be a beam separator of Wien filter type generating an electrostatic dipole field and a magnetic dipole field. In some embodiments, if they are applied, the force exerted by the electrostatic dipole field on a charged particle (e.g., an electron) of beamlets 214, 216, and 218 can be substantially equal in magnitude and opposite in a direction to the force exerted on the charged particle by magnetic dipole field. Beamlets 214, 216, and 218 can, therefore, pass straight through beam separator 222 with zero deflection angle. However, the total dispersion of beamlets 214, 216, and 218 generated by beam separator 222 can also be non-zero. Beam separator 222 can separate secondary charged-particle beams 236, 238, and 240 from beamlets 214, 216, and 218 and direct secondary charged-particle beams 236, 238, and 240 towards secondary optical system 242.

Deflection scanning unit 226 can deflect beamlets 214, 216, and 218 to scan probe spots 270, 272, and 274 over a surface area of wafer 230. In response to the incidence of beamlets 214, 216, and 218 at probe spots 270, 272, and 274, secondary charged-particle beams 236, 238, and 240 may be emitted from wafer 230. Secondary charged-particle beams 236, 238, and 240 may comprise charged particles (e.g., electrons) with a distribution of energies. For example, secondary charged-particle beams 236, 238, and 240 may be secondary electron beams including secondary electrons (energies ≤50 eV) and backscattered electrons (energies between 50 eV and landing energies of beamlets 214, 216, and 218). Secondary optical system 242 can focus secondary charged-particle beams 236, 238, and 240 onto detection sub-regions 246, 248, and 250 of charged-particle detection device 244. Detection sub-regions 246, 248, and 250 may be configured to detect corresponding secondary charged-particle beams 236, 238, and 240 and generate corresponding signals (e.g., voltage, current, or the like) used to reconstruct an SCPM image of structures on or underneath the surface area of wafer 230.

The generated signals may represent intensities of secondary charged-particle beams 236, 238, and 240 and may be provided to image processing system 290 that is in communication with charged-particle detection device 244, primary projection optical system 220, and motorized wafer stage 280. The movement speed of motorized wafer stage 280 may be synchronized and coordinated with the beam deflections controlled by deflection scanning unit 226, such that the movement of the scan probe spots (e.g., scan probe spots 270, 272, and 274) may orderly cover regions of interests on the wafer 230. The parameters of such synchronization and coordination may be adjusted to adapt to different materials of wafer 230. For example, different materials of wafer 230 may have different resistance-capacitance characteristics that may cause different signal sensitivities to the movement of the scan probe spots.

The intensity of secondary charged-particle beams 236, 238, and 240 may vary according to the external or internal structure of wafer 230, and thus may indicate whether wafer 230 includes defects. Moreover, as discussed above, beamlets 214, 216, and 218 may be projected onto different locations of the top surface of wafer 230, or different sides of local structures of wafer 230, to generate secondary charged-particle beams 236, 238, and 240 that may have different intensities. Therefore, by mapping the intensity of secondary charged-particle beams 236, 238, and 240 with the areas of wafer 230, image processing system 290 may reconstruct an image that reflects the characteristics of internal or external structures of wafer 230.

In some embodiments, image processing system 290 may include an image acquirer 292, a storage 294, and a controller 296. Image acquirer 292 may comprise one or more processors. For example, image acquirer 292 may comprise a computer, server, mainframe host, terminals, personal computer, any kind of mobile computing devices, or the like, or a combination thereof. Image acquirer 292 may be communicatively coupled to charged-particle detection device 244 of beam tool 104 through a medium such as an electric conductor, optical fiber cable, portable storage media, IR, Bluetooth, internet, wireless network, wireless radio, or a combination thereof. In some embodiments, image acquirer 292 may receive a signal from charged-particle detection device 244 and may construct an image. Image acquirer 292 may thus acquire SCPM images of wafer 230. Image acquirer 292 may also perform various post-processing functions, such as generating contours, superimposing indicators on an acquired image, or the like. Image acquirer 292 may be configured to perform adjustments of brightness and contrast of acquired images. In some embodiments, storage 294 may be a storage medium such as a hard disk, flash drive, cloud storage, random access memory (RAM), other types of computer-readable memory, or the like. Storage 294 may be coupled with image acquirer 292 and may be used for saving scanned raw image data as original images, and post-processed images. Image acquirer 292 and storage 294 may be connected to controller 296. In some embodiments, image acquirer 292, storage 294, and controller 296 may be integrated together as one control unit.

In some embodiments, image acquirer 292 may acquire one or more SCPM images of a wafer based on an imaging signal received from charged-particle detection device 244. An imaging signal may correspond to a scanning operation for conducting charged particle imaging. An acquired image may be a single image comprising a plurality of imaging areas. The single image may be stored in storage 294. The single image may be an original image that may be divided into a plurality of regions. Each of the regions may comprise one imaging area containing a feature of wafer 230. The acquired images may comprise multiple images of a single imaging area of wafer 230 sampled multiple times over a time sequence. The multiple images may be stored in storage 294. In some embodiments, image processing system 290 may be configured to perform image processing steps with the multiple images of the same location of wafer 230.

In some embodiments, image processing system 290 may include measurement circuits (e.g., analog-to-digital converters) to obtain a distribution of the detected secondary charged particles (e.g., secondary electrons). The charged-particle distribution data collected during a detection time window, in combination with corresponding scan path data of beamlets 214, 216, and 218 incident on the wafer surface, can be used to reconstruct images of the wafer structures under inspection. The reconstructed images can be used to reveal various features of the internal or external structures of wafer 230, and thereby can be used to reveal any defects that may exist in the wafer.

In some embodiments, the charged particles may be electrons. When electrons of primary charged-particle beam 210 are projected onto a surface of wafer 230 (e.g., probe spots 270, 272, and 274), the electrons of primary charged-particle beam 210 may penetrate the surface of wafer 230 for a certain depth, interacting with particles of wafer 230. Some electrons of primary charged-particle beam 210 may elastically interact with (e.g., in the form of elastic scattering or collision) the materials of wafer 230 and may be reflected or recoiled out of the surface of wafer 230. An elastic interaction conserves the total kinetic energies of the bodies (e.g., electrons of primary charged-particle beam 210) of the interaction, in which the kinetic energy of the interacting bodies does not convert to other forms of energy (e.g., heat, electromagnetic energy, or the like). Such reflected electrons generated from elastic interaction may be referred to as backscattered electrons (BSEs). Some electrons of primary charged-particle beam 210 may inelastically interact with (e.g., in the form of inelastic scattering or collision) the materials of wafer 230. An inelastic interaction does not conserve the total kinetic energies of the bodies of the interaction, in which some or all of the kinetic energy of the interacting bodies convert to other forms of energy. For example, through the inelastic interaction, the kinetic energy of some electrons of primary charged-particle beam 210 may cause electron excitation and transition of atoms of the materials. Such inelastic interaction may also generate electrons exiting the surface of wafer 230, which may be referred to as secondary electrons (SEs). Yield or emission rates of BSEs and SEs depend on, e.g., the material under inspection and the landing energy of the electrons of primary charged-particle beam 210 landing on the surface of the material, among others. The energy of the electrons of primary charged-particle beam 210 may be imparted in part by its acceleration voltage (e.g., the acceleration voltage between the anode and cathode of charged-particle source 202 in FIG. 2). The quantity of BSEs and SEs may be more or fewer (or even the same) than the injected electrons of primary charged-particle beam 210.

The images generated by SEM may be used for defect inspection. For example, a generated image capturing a test device region of a wafer may be compared with a reference image capturing the same test device region. The reference image may be predetermined (e.g., by simulation) and include no known defect. If a difference between the generated image and the reference image exceeds a tolerance level, a potential defect may be identified. For another example, the SEM may scan multiple regions of the wafer, each region including a test device region designed as the same, and generate multiple images capturing those test device regions as manufactured. The multiple images may be compared with each other. If a difference between the multiple images exceeds a tolerance level, a potential defect may be identified.

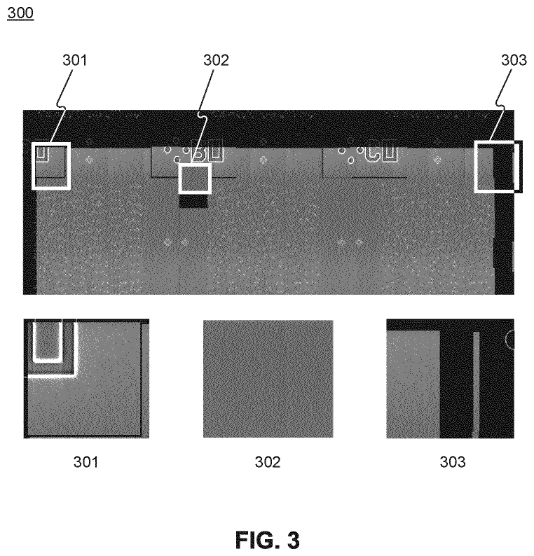

FIG. 3 illustrates a SEM image 300 with example patterns that can cause a local misalignment. As shown in FIG. 3, three example portions 301 to 303 are indicated in SEM image 300 for having patterns that can cause a local misalignment. In FIG. 3, enlargements of first to third portions 301 to 303 are illustrated at the bottom. First portion 301 illustrates a sparse pattern, second portion 302 illustrates a debris pattern, and third portion 303 illustrates a cropping debris pattern. While three patterns are illustrated as features causing a local misalignment, it will be appreciated that various features may cause a local misalignment of an SEM image.

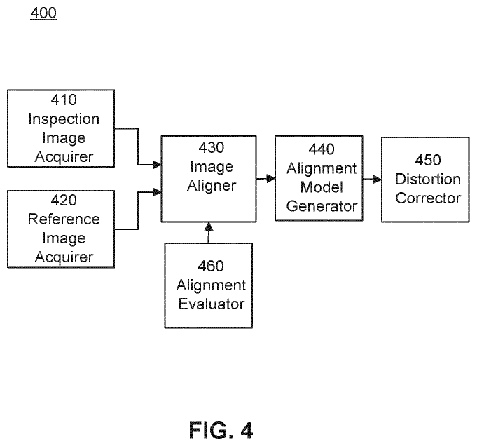

Reference is now made to FIG. 4, which is a block diagram of an example distortion correction system, consistent with embodiments of the present disclosure. In some embodiments, a distortion correction system 400 comprises one or more processors and memories. It is appreciated that in various embodiments distortion correction system 400 may be part of or may be separate from a charged-particle beam inspection system (e.g., EBI system 100 of FIG. 1), or computational lithography system, or other photolithography systems. In some embodiments, distortion correction system 400 may include one or more components (e.g., software modules) that can be implemented in controller 109 or system 290 as discussed herein. As shown in FIG. 4, distortion correction system 400 may comprise an inspection image acquirer 410, a reference image acquirer 420, an image aligner 430, an alignment model generator 440, and a distortion corrector 450.

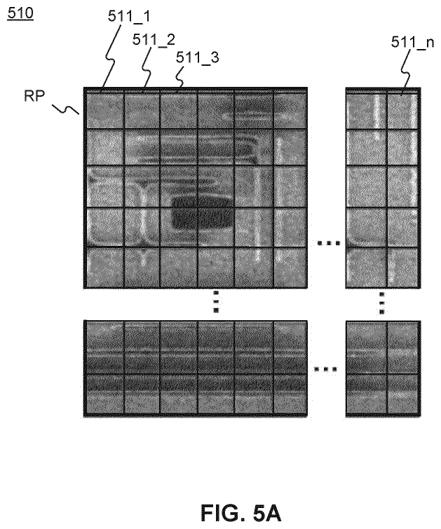

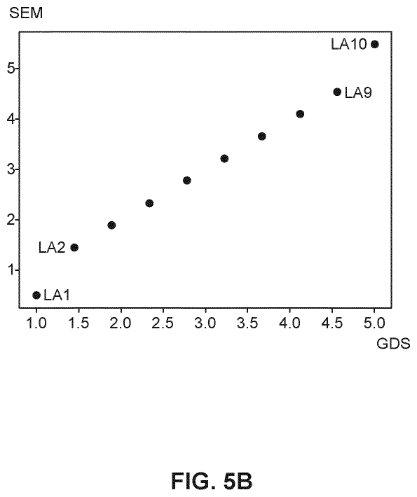

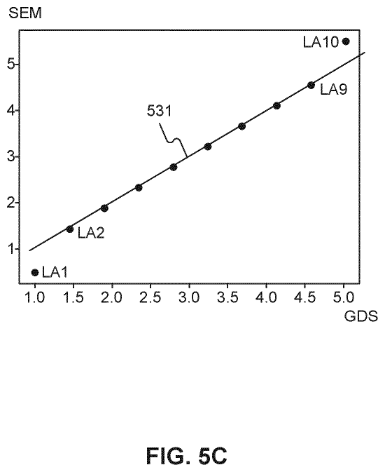

According to some embodiments of the present disclosure, inspection image acquirer 410 can acquire an inspection image as an input image. In some embodiments, an inspection image is a SEM image of a sample or a wafer. In some embodiments, an inspection image can be an inspection image generated by, e.g., EBI system 100 of FIG. 1 or electron beam tool 104 of FIG. 2. In some embodiments, inspection image acquirer 410 may obtain an inspection image from a storage device or system storing the inspection image. FIG. 5A illustrates an example inspection image 510, which will be explained in detail with respect to some embodiments in the present disclosure.

Referring back to FIG. 4, according to some embodiments, reference image acquirer 420 can acquire a reference image corresponding to an inspection image acquired by inspection image acquirer 410. In some embodiments, a reference image can be a layout file for a wafer design corresponding to the inspection image. The layout file can be in a Graphic Database System (GDS) format, Graphic Database System II (GDS II) format, an Open Artwork System Interchange Standard (OASIS) format, a Caltech Intermediate Format (CIF), etc. The wafer design may include patterns or structures for inclusion on the wafer. The patterns or structures can be mask patterns used to transfer features from the photolithography masks or reticles to a wafer. In some embodiments, a layout in GDS or OASIS format, among others, may comprise feature information stored in a binary file format representing planar geometric shapes, text, and other information related to the wafer design. In some embodiments. a reference image can be an image rendered from the layout file.

According to some embodiments of the present disclosure, image aligner 430 can segment an inspection image into a plurality of smaller patches. It is illustrated in FIG. 5A that inspection image 510 is segmented into a plurality of patches 511_1 to 511_n. While it is illustrated in FIG. 5A that inspection image 510 is segmented in two dimensions, it will be appreciated that inspection image 510 can be segmented in any dimension(s). In FIG. 5A, it is shown that a first row of inspection image 510 is segmented into n number of patches 511_1 to 511_n. While some embodiments will be explained referring to patches arranged in one dimension (e.g., in a horizontal direction in FIG. 5A), it will be appreciated that the present disclosure can apply to patches in various dimensions.

After segmenting inspection image 510 into a plurality of patches 511_1 to 511_n, image aligner 430 is configured to align a plurality of patches 511_1 to 511_n to a reference image corresponding to inspection image 510. In some embodiments, aligning a plurality of patches 511_1 to 511_n to a reference image can be performed based on feature matching between patch 511_1 to 511_n and a reference image. In some embodiments, image aligner 430 can determine, for each of a plurality of patches 511_1 to 511_n, a corresponding portion or patch in a reference image. In some embodiments of the present disclosure, during aligning a plurality of patches 511_1 to 511_n, a corresponding patch of a reference image can be determined for each patch of an inspection image.

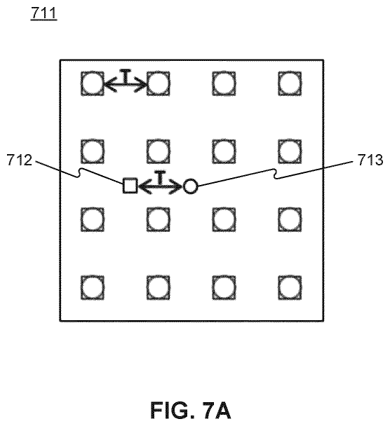

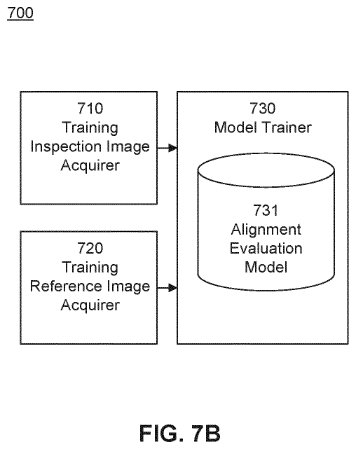

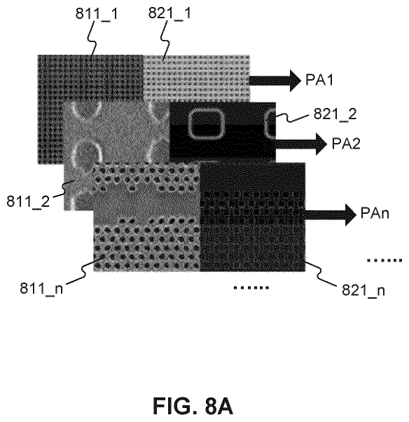

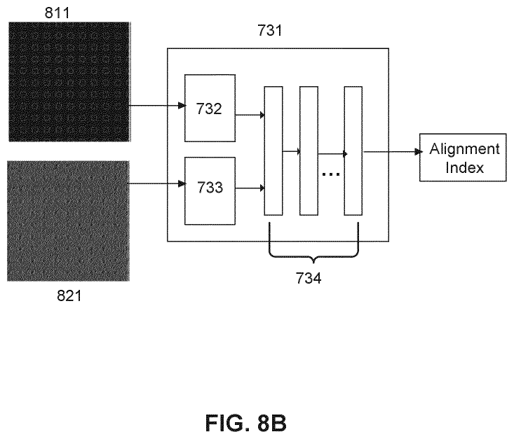

According to some embodiments of the present disclosure, distortion correction system 400 can further comprise an alignment evaluator 460. Alignment evaluator 460 can be configured to evaluate whether a plurality of patches of an inspection image are well aligned to corresponding patches of a reference image, consistent with some embodiments of the present disclosure. In some embodiments, alignment evaluator 460 can produce an alignment index for each patch of an inspection image by evaluating whether the patch of the inspection image is well aligned to a corresponding patch of a reference image. In some embodiments, the alignment index can represent a degree of confidence that a patch of an inspection image is aligned to a corresponding patch of a reference image. In some embodiments, an alignment evaluation can be performed based on patches (e.g., patches 511_1 to 511_n) used when performing an alignment by image aligner 430. In some embodiments, an alignment evaluation can be performed based on patches that are different from patches 511_1 to 511_n used by image aligner 430. For example, patches 511_1 to 511_n can be put together based on the alignment, and alignment evaluator 460 can re-segment the integrated patches into a different set of patches to be used for an alignment evaluation. The re-segmented patches may have a different size or a different shape from those of patches 511_1 to 511_n. In some embodiments, alignment evaluator 460 can evaluate whether an inspection image is well aligned to a reference image based on alignment evaluation results for a plurality of patches of an inspection image. In some embodiments, image aligner 430 can receive alignment evaluation result(s) from alignment evaluator 460 and can realign a plurality of patches of an inspection image to a reference image according to the alignment evaluation result(s). In some embodiments, alignment evaluator 460 can be a machine learning based alignment algorithm. A training technique for the machine learning based alignment evaluation algorithm will be explained referring to FIGS. 7A to 8B.

In some embodiments, based on alignments of a plurality of patches 511_1 to 511_n to a reference image, local alignment results for a plurality of patches 511_1 to 511_n can be generated. FIG. 5B is an example graph illustrating local alignment results for a plurality of patches, consistent with embodiments of the present disclosure. In FIG. 5B, ten local alignment results LA are indicated in a two-dimensional coordinate system where an x-axis represents a position in a reference image, e.g., GDS file, and a y-axis represents a position in inspection image 510, e.g., SEM image. In FIG. 5A, local alignment result LA can be associated with one patch of a plurality of patches 511_1 to 511_n. In some embodiments, local alignment result LA of each patch can be a measured distance from a reference point in an inspection image, e.g., reference point RP in inspection image 510 of FIG. 5A to a center of each patch.

In FIG. 5B, a first local alignment result LA1, which is associated with first patch 511_1. indicates that a position of first patch 511_1 in inspection image 510 is about 0.4 from reference point RP while a position of a corresponding patch in a reference image is 1 from a corresponding reference point in the reference image. A second local alignment result LA2, which is associated with second patch 511_2, indicates that a position of second patch 511_2 in inspection image 510 is about 1.45 from reference point RP while a position of a corresponding patch in a reference image is 1.5 from a corresponding reference point in the reference image. Similarly, a tenth local alignment result LA10, which is associated with a tenth patch, indicates that a position of the tenth patch in inspection image 510 is about 5.6 while a position of a corresponding patch in a reference image is 5 from a corresponding reference point in a reference image. Please note that in the present disclosure a positive symbol (+) to indicate a right direction in FIG. 5A will be omitted, and a negative symbol (−) will be used to indicate a direction opposite to the right direction.

Referring back to FIG. 4, according to some embodiments of the present disclosure, alignment model generator 440 is configured to generate an alignment model that can be used to correct a distortion of an inspection image, e.g., inspection image 510. According to some embodiments of the present disclosure, alignment model generator 440 can generate an alignment model based on local alignment results. According to some embodiments of the present disclosure, alignment model generator 440 can generate an alignment model that fits as many local alignment results as possible, e.g., as shown in FIG. 5C. As shown in FIG. 5C, an alignment model 531 fits 8 local alignment results (i.e., LA2 to LA9) out of 10 local alignment results (i.e., LA1 to LA10). In the present disclosure, a local alignment result that fits an alignment model can be referred to as an inlier, and a local alignment result that does not fit an alignment model can be referred to as an outlier. In FIG. 5C, 8 local alignment results, i.e., LA2 to LA9 are inliers, and 2 local alignment results, i.e., LA1 and LA10 are outliers with respect to alignment model 531. In some embodiments, it can be assumed that an outlier(s) is flawed or contaminated data, e.g., caused by snapping, half-pitch shift, etc. In some embodiments, these outlier(s) are excluded in estimating an alignment model.

According so some embodiments, an alignment model that can minimize the L0 norm that counts the total number of a nonzero distance between local alignment results and the alignment model can be determined as an alignment model for a corresponding inspection image. In FIG. 5C, 8 local alignment results LA2 to LA9 that fit alignment model 531 have a zero distance from alignment model 531 and 2 local alignment results LA1 and LA0 have a nonzero distance from alignment model 531. According to some embodiments, potential flawed data can be recognized and disregarded in generating an alignment model and thereby the effect of flawed data can be minimized in correcting distortion of inspection image 510.

According to some embodiments of the present disclosure, estimating an alignment model can be performed based on random sample consensus (RANSAC) that is represented as follows:

Algorithm 1

```
FOR epoch in N:
  LAₛ = Sample (O, epoch, LA)
  F=Fit (LAₛ)
  F*=Evaluate (F, Pₜ, LA)
END FOR.
```

Here, N represents a total number of iterations, epoch represents a current iteration number, O represents a regression order, and LA represents a local alignment result, e.g., LA1 to LA10 in FIG. 5C,

In a first step, a sample subset of local alignment results is randomly selected from a set of local alignment results according to regression order O. Regression order O may represent any order of regression according to embodiments. A number of local alignment results for a sample subset can be determined based on regression order O to uniquely define an alignment model, e.g., an alignment curve. For example, when regression order O identifies a first order of regression that is also referred to as linear regression, a sample subset of two local alignment results can be randomly selected. In the present disclosure, embodiments where two local alignment results are selected for a sample subset will be explained for illustration purposes. The subset including the selected alignment results are indicated as LAₛ.

In a second step, a first alignment model F that fits the selected alignment results included in subset LAₛ can be determined, consistent with some embodiments of the present disclosure. In some embodiments, first alignment model F can be a linear or nonlinear model according to regression order O. In some embodiments, parameters of first alignment model F that fits the selected alignment results included in subsets LAₛ and that satisfies the defined regression order O can be computed. For example, when second and ninth local alignment results LA2 and LA9 are selected in the first step and first order regression is defined by regression order O, alignment model 531, which is a linear equation, can be uniquely identified.

In a third step, first alignment model F obtained in the second step can be evaluated by checking how many local alignment results in the entire dataset fit first alignment model F. According to some embodiments, performance Pₜ of first alignment model F can be determined based on a number of local alignment results fitting first alignment model F. In some embodiments, a local alignment result that fits first alignment model F is considered as an inlier and a local alignment result that does not fit first alignment model F is considered as an outlier. In some embodiments, when a local alignment result does not fit first alignment model F but is close enough, the local alignment result can be considered as an inlier. For example, a local alignment result of which distance from first alignment model F is within a threshold value can be considered as fitting the first alignment model F. In some embodiments, the threshold value may be determined based on whether the deviation from first alignment model F can be attributed to the effect of noise. In some embodiments, performance Pₜ of first alignment model F can be determined based on a percentage of inlier(s) among entire dataset. For example, in FIG. 5C, among 10 local alignment results 8 local alignment results LA2 to LA9 fit fitting curve 531 as first alignment model F, and therefore performance Pₜ of first alignment model F can be determined as 80%. In some embodiments, performance Pₜ of first alignment model F can be determined based on a percentage of inlier(s) among a remainder set. For example, when a sample subset includes second and ninth local alignment results LA2 and LA9, 6 local alignment results among 8 local alignment results in a remainder set are inliers, and thus performance Pₜ of first alignment model F can be determined as 75%. In this step, first alignment model F is considered as a potential alignment model F*.

As discussed above, the first step to third step can be repeated for N number of iterations. After a first iteration is completed, a second iteration is performed. In a first step, constituting a subset of the second iteration can be randomly selected among the entire dataset. Local alignment results selected in the second iteration may be different from those selected in the first iteration. In a second step, second alignment model F is estimated based on the selected local alignment results, and in a third step, performance Pₜ of second alignment model F is evaluated in a similar manner of a first iteration. In the third step, when performance Pₜ of second alignment model F is better than performance Pₜ of first alignment model F in the first iteration, second alignment model F is updated as potential alignment model F*. Otherwise, first alignment model F is maintained as potential alignment model F*. Accordingly, when N number of iterations are completed, alignment model F that has the highest performance Pₜ among N number of alignment models F can be selected as alignment model F* for an inspection image 510.

Referring back to FIG. 4, distortion corrector 450 can be configured to correct distortion(s) of an inspection image based on selected alignment model F*, consistent with some embodiments of the present disclosure. In some embodiments, all patches of an inspection image corresponding to all local alignment results including inliers and outliers of the inspection image can be corrected based on selected alignment model F*. For example, in FIG. 5C, a second patch corresponding to second local alignment result LA2 that is an inlier with respect to alignment model 531 is corrected according to alignment model 531. To correct distortions of inspection image 510, second patch 511_1 corresponding to second local alignment result LA2 can be moved by 0.05 according to alignment model 531 in FIG. 5C. Similarly, in FIG. 5C, a first patch corresponding to first local alignment result LA1 that is an outlier with respect to alignment model 531 is also corrected according to alignment model 531 instead of the measured local alignment result LA1. To correct inspection image 510, first patch 511_1 corresponding to first local alignment result LA1 can be moved by (−) 0.05 according to fitting model 531 instead of 0.6 according to measured local alignment result LA1 in FIG. 5C. While a linear alignment model is illustrated in some embodiments of the present disclosure, it will be appreciated that present disclosure can apply to any types of alignment models comprising, but not limited to, scaling, rotation, translation, etc.

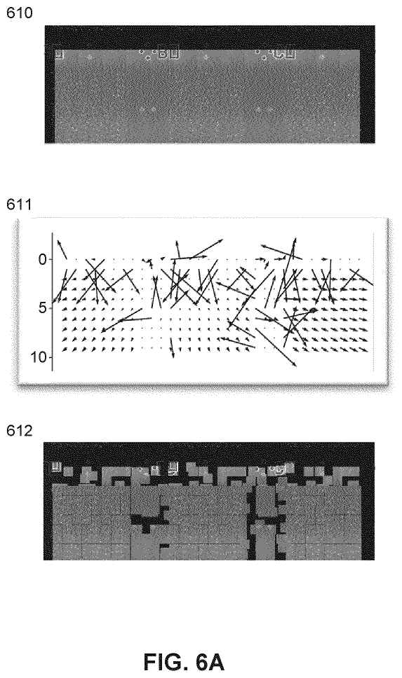

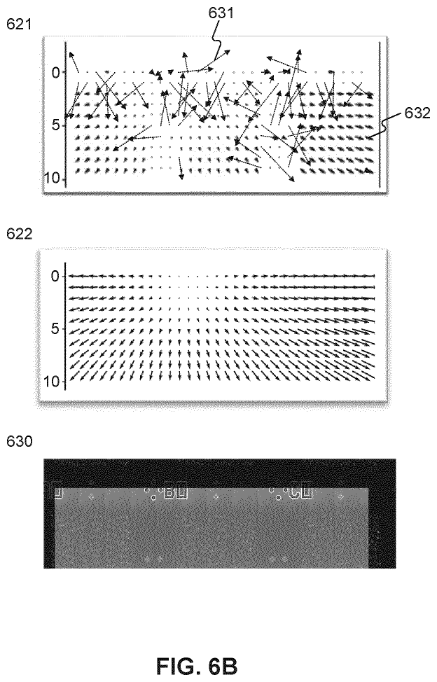

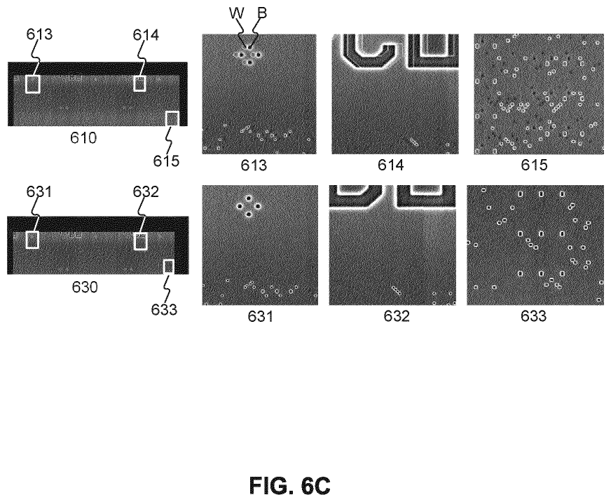

FIG. 6A illustrates an example process correcting distortions of a SEM image according to local alignment data. In FIG. 6A, a SEM image 610 is a SEM image that is programed to include 1% distortion among 1000 pixels. In FIG. 6A, a first arrow map 611 illustrates measured local alignment results for each pixel in SEM image 610. In first arrow map 611, each arrow represents how much and in which direction a corresponding pixel should move to match a corresponding reference image according to a corresponding measured local alignment result. In FIG. 6A, first corrected image 612 is a corrected image of SEM image 610 according to first arrow map 611. As shown in corrected SEM image 612, correcting an inspection image according to measured local alignment results can lead to another type of misalignments or distortion, such as snapping.

FIG. 6B illustrates an example process correcting distortions of a SEM image according to an alignment model consistent with embodiments of the present disclosure. Here, SEM image 610 of FIG. 6A is also used as an input inspection image. In FIG. 6B, a second arrow map 621 represents arrows 632 corresponding to inliers and arrows 631 corresponding to outliers among arrows in first arrow map 611 with respect to a selected alignment model consistent with some embodiments of the present disclosure. A third arrow map 622 illustrates fitting results for SEM image 610 according a selected alignment model. As shown in third arrow map 622 in FIG. 6B, arrows 631 corresponding to outliers are not considered but fitting results according to a selected alignment model are considered in correcting distortions of SEM image 610. In third arrow map 622, each arrow represents how much and in which direction a corresponding pixel should move to match a corresponding reference image according to a selected alignment model. In FIG. 6B, second corrected image 630 is a corrected image of SEM image 610 according to third arrow map 622. As shown as second corrected SEM image 630. distortions of an inspection image can be effectively corrected according to an alignment model consistent with some embodiments of the present disclosure. For example, in some instances up to 99.98% of distortions programed into SEM image 610 have been corrected in SEM image 630.

FIG. 6C illustrates an example comparison between an input inspection image and an output corrected image after a distortion correction consistent with embodiments of the present disclosure. In FIG. 6C. SEM image 610 and corrected SEM image 630 are SEM images before and after a distortion correction consistent with some embodiments of the present disclosure respectively. SEM image 610 includes portions 613, 614, and 615 that are not well aligned to a corresponding reference image. In enlarged images of portions 613. 614, and 615, patterns W of SEM image 610 are indicated as a white hollow circle. Patterns B of a corresponding GDS image are also indicated in enlarged imaged of portions 613, 614, and 615 for illustration purposes. It is noted that SEM image 610 is not well aligned with a corresponding GDS image as shown in enlarged images of portions 613, 614, and 615. Corrected SEM image 630 also includes portions 631, 632, and 633 corresponding to portions 613, 614, and 615 of input SEM image 610. It is noted that in the enlarged images of portions 631. 632, and 633, patterns W of SEM image 630 are well aligned with patterns B of a corresponding GDS image. As shown in FIG. 6C, distortions of an input SEM image can be effectively corrected according to some embodiments of the present disclose.

In order to improve distortion correction performance on a SEM image, it is important to accurately align a SEM image to a design layout at the outset. As illustrated referring to alignment evaluator 460 of FIG. 4, whether a SEM image is well aligned to a reference image can be performed before generating an alignment model based on local alignment results. There are many mechanisms that provide alignment confidence scores. However, alignment confident scores are generally calculated by cross correlation or mean-squared error (MSE) based matching algorithms, which does not provide robust matching scores when a field-of-view includes a relatively large portion of repeating patterns and lacks unique features or sufficient underlying information from defects. Under these algorithms, alignment confidence scores can still be high even when a SEM image with repeating patterns is misaligned.

FIG. 7A illustrates an example inspection image with shifted repetitive patterns. In FIG. 7A. it is illustrated that a SEM image is not aligned with a reference image, i.e., the SEM image is shifted by a distance T from the reference image. For example, a pattern 712 of a SEM image 711 is shifted from its corresponding pattern 713 of the reference image. However, an alignment confidence score by cross correlation or mean-squared error (MSE) based matching algorithms can still be high for SEM image 711 because patterns of SEM image 711 are repeating as shown in FIG. 7A, It is noted that cross-correlation or MSE based confidence scores can produce false positive results on alignments of a SEM image including repeating patterns. According to some embodiments of the present disclosure, alignment evaluator 460 can be a machine learning based alignment algorithm and the alignment evaluation model can be trained by a training system.

FIG. 7B is a block diagram of a training system 700 (also referred to as “apparatus 700”) for an alignment evaluation model, consistent with embodiments of the present disclosure. In some embodiments, training system 700 may comprise one or more processors and memories. It is appreciated that in various embodiments training system 700 may be part of or may be separate from a charged-particle beam inspection system (e.g., EBI system 100 of FIG. 1). It is also appreciated that training system 700 may include one or more components or modules separate from and communicatively coupled to the charged-particle beam inspection system. In some embodiments, training system 700 may include one or more components (e.g., software modules) that can be implemented in controller 109 or system 290 as discussed herein. In some embodiments, training system 700 and distortion correction system 400 are implemented on separate computing devices or on a same computing device. In some embodiments, training system 700 may be part of distortion correction system 400 or alignment evaluator 460 of distortion correction system 400 of FIG. 4.

As shown in FIG. 7B, training system 700 may comprise a training inspection image acquirer 710, a training reference image acquirer 720, and a model trainer 730. According to some embodiments of the present disclosure, training inspection image acquirer 710 can acquire an inspection image patch. In some embodiments, an inspection image patch is a patch of a SEM image of a sample or a wafer. In some embodiments, a training inspection image can be one of a plurality patches of a SEM image. For example, a training inspection image can be one of patches 511_1 to 511_n illustrated in FIG. 5A.

According to some embodiments, training reference image acquirer 720 can acquire a reference image to be compared to a training inspection image acquired by training inspection image acquirer 710. In some embodiments, a reference image can be a layout file for a wafer design. In some embodiments, a training reference image may be or may not be well aligned to a training inspection image for training purposes.

FIG. 8A illustrates example training data sets for a training system of FIG. 7B, consistent with embodiments of the present disclosure. FIG. 8A illustrates example pairs of a training inspection image and a training reference image acquired by training inspection image acquirer 710 and training reference image acquirer 720, respectively. In FIG. 8A, training inspection image acquirer 710 can acquire training inspection image patches 811_1 to 811_n and training reference image acquirer 720 can acquire training reference image patches 821_1 to 821_n. In some embodiments, each training inspection image 811 is paired with a training reference image 821. For example, first training inspection image 811_1 is paired with a first training reference image 821_1, which constitutes a first pair PA1. Similarly, a second pair PA2 to an n^{th} pair PAn are acquired.

Referring back to FIG. 7B, according to some embodiments of the present disclosure, model trainer 730 is configured to train alignment evaluation model 731 to predict an alignment index of two images of each pair PA1 to PAn provided as inputs. According to some embodiments of the present disclosure, model trainer 730 is configured to train alignment evaluation model 731 under supervised learning. In some embodiments, model trainer 730 is also provided with information whether training inspection image 811 and training reference image 812 are aligned or not.

FIG. 8B illustrates an example configuration of alignment evaluation model 731, consistent with embodiments of the present disclosure. As shown in FIG. 8B, alignment evaluation model 731 can receive training inspection image 811 and training reference image 821 and processes the two images to predict how well the two images are aligned. In some embodiments, alignment evaluation model 731 can be configured to provide an alignment index that represents an alignment degree between two images. In some embodiments, alignment evaluation model 731 can be a machine learning system or neural network such as a Siamese neural network. It is appreciated that other types of machine learning systems can be utilized.

As shown in FIG. 8B, alignment evaluation model 731 can be configured to include a first network 732 and a second network 733, consistent with some embodiments of the present disclosure. In some embodiments, training inspection image 811 is provided to first network 732 that is configured to extract features of training inspection image 811, and training reference image 821 is provided to second network 733 that is configured to extract features of reference image 821. In some embodiments, first network 732 and second network 733 can be configured to have the same configurations. For example, first network 732 and second network 733 may be configured to have shared weights such that two networks 732 and 733 can work in tandem on two different inputs to compute comparable outputs, e.g., as output vectors. In some embodiments, first network 732 and second network 733 can be configured to have independent configurations. In this instance, first network 732 and second network 733 may not share weights. In some embodiments, first network 732 and second network 733 can be implemented by various network architectures comprising, but not limited to, a Visual Geometry Group (VGG) neural network, a Residual neural network (ResNet), a Dense Convolutional network (DenseNet), etc.

As shown in FIG. 8B, alignment evaluation model 731 can further include processing layers 734, consistent with some embodiments of the present disclosure. In some embodiments, features from first network 732 and features from second network 733 can be provided to processing layers 734. As shown in FIG. 8B, processing layers 734 can include multiple processing layers that process input features from two networks 732 and 733 to output an alignment index between two images 811 and 821. In some embodiments, processing layers 734 may compute convolution operations on the input features. In some embodiments, features from first network 732 and features from second network 733 can be combined at an input layer of processing layers 734 and then processed further to output an alignment index.

When an alignment index is not consistent with information whether training inspection image 811 and training reference image 812 are aligned or not, model trainer 730 may adjust parameters, weights, etc. of alignment evaluation model 731. As alignment evaluation model 731 is trained with additional pairs PA1 to PAn of training inspection image 811 and training reference image 812. accuracy of an alignment index produced by alignment evaluation model 731 can improve.

After model trainer 730 trains alignment evaluation model 731 under supervised learning, alignment evaluation model 731 can be used as alignment evaluator 460, consistent with some embodiments of the present disclosure. In some embodiments, trained alignment evaluation model 731 can be used to predict an alignment index between an input image and a reference image. In some embodiments, trained alignment evaluation model 731 may be used independently from or in conjunction with correcting a distortion of an inspection image. In some embodiments, trained alignment evaluation model 731 can be used in a print check process. In a print check process, a mask or reticle can be inspected by exposing a wafer with the mask and inspecting the wafer to check whether any defects are repeated, which may indicate a defect on the mask. In this application, trained alignment evaluation model 731 can be used to evaluate an alignment between an inspection image of the wafer and a corresponding layout image of the wafer.

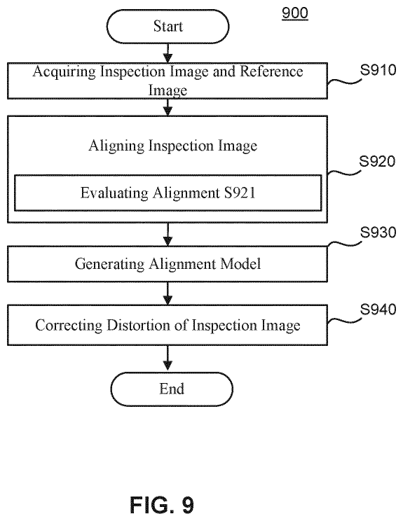

FIG. 9 is a process flowchart representing an exemplary method for correcting a distortion of an inspection image, consistent with embodiments of the present disclosure. The steps of method 900 can be performed by a system (e.g., system 400 of FIG. 4) executing on or otherwise using the features of a computing device, e.g., controller 109 of FIG. 1. It is appreciated that the illustrated method 900 can be altered to modify the order of steps and to include additional steps.

In step S910, an inspection image and a reference image are acquired. Step S910 can be performed by, for example, inspection image acquirer 410 or reference image acquirer 420, among others. In some embodiments, an inspection image is a SEM image of a sample or a wafer. In some embodiments, a reference image can be a layout file for a wafer design corresponding to the inspection image. In some embodiments, a reference image can be an image rendered from the layout file.

In step S920, an inspection image is aligned to a reference image. Step S920 can be performed by, for example, image aligner 430, among others. According to some embodiments of the present disclosure, an inspection image can be segmented into a plurality of smaller patches. It is illustrated in FIG. 5A that inspection image 510 is segmented into a plurality of patches 511_1 to 511_n. After segmenting inspection image 510 into a plurality of patches 511_1 to 511_n, a plurality of patches 511_1 to 511_n are aligned to a reference image corresponding to inspection image 510. In some embodiments, aligning a plurality of patches 511_1 to 511_n to a reference image can be performed based on feature matching between patch 511_1 to 511_n and a reference image. In some embodiments of the present disclosure, during aligning a plurality of patches 511_1 to 511_n, a corresponding patch of a reference image can be determined for each patch of an inspection image.

According to some embodiments of the present disclosure, method 900 can further perform step S921. In step S921, an alignment of an inspection image performed in step S920 can be evaluated. Step S921 can be performed by, for example, alignment evaluator 460, among others. In step S921, whether a plurality of patches of an inspection image are well aligned to corresponding patches of a reference image can be evaluated, an alignment index can be produced for each patch of an inspection image by evaluating whether the patch of the inspection image is well aligned to a corresponding patch of a reference image. In some embodiments, the alignment index can represent a degree of confidence that a patch of an inspection image is aligned to a corresponding patch of a reference image. In some embodiments, whether an inspection image is well aligned to a reference image based on alignment evaluation results for a plurality of patches of an inspection image can be evaluated. In some embodiments, step S920 can be repeated to realign a plurality of patches of an inspection image to a reference image according to the alignment evaluation result(s). In some embodiments, step S921 can be a machine learning based alignment algorithm.

In step S930, an alignment model is generated. Step S930 can be performed by, for example, alignment model generator 440, among others. In some embodiments, based on alignments of a plurality of patches 511_1 to 511_n to a reference image, local alignment results for a plurality of patches 511_1 to 511_n can be generated. According to some embodiments of the present disclosure, an alignment model that can be used to correct a distortion of an inspection image can be generated based on local alignment results. According to some embodiments of the present disclosure, an alignment model that fits as many local alignment results as possible can be generated. According so some embodiments, an alignment model that can minimize the L0 norm that counts the total number of a nonzero distance between local alignment results and the alignment model can be determined as an alignment model for a corresponding inspection image. In some embodiments, it can be assumed that an outlier(s) is flawed or contaminated data, e.g., caused by snapping, half-pitch shift, etc. In some embodiments, these outlier(s) are excluded in estimating an alignment model.

According to some embodiments of the present disclosure, estimating an alignment model can be performed based on random sample consensus (RANSAC). According to some embodiments of the present disclosure, a plurality of alignment algorithms can be generated for a plurality of randomly selected subsets of local alignment results. In some embodiments, one alignment algorithm that shows the highest performance among the plurality of alignment algorithms can be selected as an alignment algorithm to correct an inspection image. In some embodiments, the performance of an alignment algorithm can be determined based on a number of local alignment results fitting the alignment algorithm. The process of generating an alignment model has been described referring to Algorithm 1 in the present disclosure, and thus the detailed explanation will be omitted here for simplicity purposes.

In step S940, a distortion(s) of an inspection image is corrected based on selected alignment model. Step S940 can be performed by, for example, distortion corrector 450, among others. In some embodiments, all patches of an inspection image corresponding to all local alignment results including inliers and outliers of the inspection image can be corrected based on a selected alignment model F.

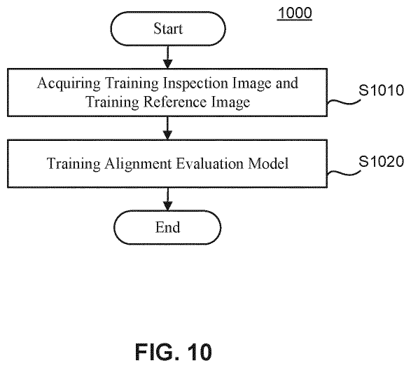

FIG. 10 is a process flowchart representing an exemplary method for training an alignment evaluation model, consistent with embodiments of the present disclosure. The steps of method 1000 can be performed by a system (e.g., system 700 of FIG. 7B) executing on or otherwise using the features of a computing device, e.g., controller 109 of FIG. 1 for purposes of illustration. It is appreciated that the illustrated method 1000 can be altered to modify the order of steps and to include additional steps.

In step S1010, a pair of a training inspection image and a training reference image is acquired. Step S1010 can be performed by, for example, training inspection image acquirer 710 or training reference image acquirer 720, among others. A training inspection image can be an inspection image patch. In some embodiments, an inspection image patch is a patch of a SEM image of a sample or a wafer. According to some embodiments, a training reference image can be a reference image patch to be compared to a training inspection image. In some embodiments, a reference image can be a layout file for a wafer design. In some embodiments, a training reference image may or may not correspond to a training inspection image for training purposes.

In step S1020, an alignment evaluation model is trained. Step S1020 can be performed by, for example, model trainer 730, among others. According to some embodiments of the present disclosure, an alignment evaluation model is trained to predict an alignment index of two images provided as inputs. According to some embodiments of the present disclosure, an alignment evaluation model is trained under supervised learning. In some embodiments, information whether a training inspection image and a training reference image are aligned or not can be provided. In some embodiments, an alignment evaluation model can be configured to provide an alignment index that represents an alignment degree between two images. When an alignment index is not consistent with information whether a training inspection image and a training reference image are aligned or not, parameters, weights, etc. of an alignment evaluation model can be adjusted. As an alignment evaluation model is trained with additional pairs of a training inspection image and a training reference image, accuracy of an alignment index produced by alignment evaluation model 731 can improve. The example configuration of an alignment evaluation model has been described referring to FIG. 8B, and thus the detailed explanation thereof will be omitted here for simplicity purposes.

A non-transitory computer readable medium may be provided that stores instructions for a processor of a controller (e.g., controller 109 of FIG. 1) to carry out, among other things, image inspection, image acquisition, stage positioning, beam focusing, electric field adjustment, beam bending, condenser lens adjusting, activating charged-particle source, beam deflecting, and methods 900 and 1000. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:
1. A method for correcting distortion of an inspection image, comprising: acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.
2. The method of clause 1, wherein evaluating the alignment model comprises: determining, in the remainder set of the local alignment results, a percentage of local alignment results that fit the alignment model.
3. The method of clause 1 or 2, wherein the plurality of subsets are randomly selected.
4. The method of any one of clauses 1-3, further comprising:
aligning the plurality of patches of the inspection image based on the reference image; and
evaluating, by a machine learning model, an alignment between a first patch of the plurality of patches and a corresponding patch of the reference image.
5. The method of clause 4, further comprising:
acquiring a training inspection image patch and a training reference image patch; and
training the machine learning model to predict an alignment index between the training inspection image patch and the training reference image patch.
6. An apparatus for correcting distortion of an inspection image, the apparatus comprising:
a memory storing a set of instructions; and
at least one processor configured to execute the set of instructions to cause the apparatus to perform:
acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.
7. The apparatus of clause 6, wherein, in evaluating the alignment model, the at least one processor is configured to execute the set of instructions to cause the apparatus to further perform:
determining, in the remainder set of the local alignment results, a percentage of local alignment results that fit the alignment model.
8. The apparatus of clause 6 or 7, wherein the plurality of subsets are randomly selected.
9. The apparatus of any one of clauses 6-8, wherein the at least one processor is configured to execute the set of instructions to cause the apparatus to further perform:
aligning the plurality of patches of the inspection image based on the reference image; and
evaluating, by a machine learning model, an alignment between a first patch of the plurality of patches and a corresponding patch of the reference image.
10. The apparatus of clause 9, wherein the at least one processor is configured to execute the set of instructions to cause the apparatus to further perform:
acquiring a training inspection image patch and a training reference image patch; and
training the machine learning model to predict an alignment index between the training inspection image patch and the training reference image patch.
11. A non-transitory computer readable medium that stores a set of instructions that is executable by at least on processor of a computing device to cause the computing device to perform a method for correcting distortion of an inspection image, the method comprising:
acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.
12. The computer readable medium of clause 11, wherein, in evaluating the alignment model, the set of instructions that is executable by at least one processor of the computing device cause the computing device to further perform:
determining, in the remainder set of the local alignment results, a percentage of local alignment results that fit the alignment model.
13. The computer readable medium of clause 11 or 12, wherein the plurality of subsets are randomly selected.
14. The computer readable medium of any one of clauses 11-13, wherein the set of instructions that is executable by at least one processor of the computing device cause the computing device to further perform:
aligning the plurality of patches of the inspection image based on the reference image; and
evaluating, by a machine learning model, an alignment between a first patch of the plurality of patches and a corresponding patch of the reference image.
15. The computer readable medium of clause 14, wherein the set of instructions that is executable by at least one processor of the computing device cause the computing device to further perform:
acquiring a training inspection image patch and a training reference image patch; and
training the machine learning model to predict an alignment index between the training inspection image patch and the training reference image patch.
16. A method for correcting distortion of an inspection image, comprising:
acquiring an inspection image;
determining local alignment results for a plurality of patches of the inspection image based on a reference image corresponding to the inspection image;
estimating a first alignment model based on a first subset of the local alignment results and estimating a second alignment model based on a second subset of the local alignment results;
evaluating the first alignment model based on a fit of the first alignment model to a first remainder set of the local alignment results and evaluating the second alignment model based on a fit of the second alignment model to a second remainder set of the local alignment results;
selecting one of the first alignment model and the second alignment model based on the evaluations; and
correcting a distortion of the inspection image based on the selected alignment model.
17. The method of clause 16, wherein evaluating the first alignment model comprises:
determining, in the first remainder set of the local alignment results, a percentage of local alignment results that fit the first alignment model.
18. The method of clause 16 or 17, wherein the first subset and the second subset are randomly selected.
19. The method of any one of clauses 16-18, further comprising:
aligning the plurality of patches of the inspection image based on the reference image;
evaluating, by a machine learning model, an alignment between a first patch of the plurality of patches and a corresponding patch of the reference image.
20. The method of clause 19, further comprising:
acquiring a training inspection image patch and a training reference image patch;
training the machine learning model to predict an alignment index between the training inspection image patch and the training reference image patch.
21. An apparatus for correcting distortion of an inspection image, comprising:
a memory storing a set of instructions; and
at least one processor configured to execute the set of instructions to cause the apparatus to perform: acquiring an inspection image;
determining local alignment results for a plurality of patches of the inspection image based on a reference image corresponding to the inspection image;
estimating a first alignment model based on a first subset of the local alignment results and estimating a second alignment model based on a second subset of the local alignment results;
evaluating the first alignment model based on a fit of the first alignment model to a first remainder set of the local alignment results and evaluating the second alignment model based on a fit of the second alignment model to a second remainder set of the local alignment results;
selecting one of the first alignment model and the second alignment model based on the evaluations; and
correcting a distortion of the inspection image based on the selected alignment model.
22. The apparatus of clause 21, wherein, in evaluating the first alignment model, the at least one processor is configured to execute the set of instructions to cause the apparatus to further perform:
determining, in the first remainder set of the local alignment results, a percentage of local alignment results that fit the first alignment model.
23. The apparatus of clause 21 or 22, wherein the first subset and the second subset are randomly selected.
24. The apparatus of any one of clauses 21-23, wherein the at least one processor is configured to execute the set of instructions to cause the apparatus to further perform:
aligning the plurality of patches of the inspection image based on the reference image; and
evaluating, by a machine learning model, an alignment between a first patch of the plurality of patches and a corresponding patch of the reference image.
25. The apparatus of clause 24, wherein the at least one processor is configured to execute the set of instructions to cause the apparatus to further perform:
acquiring a training inspection image patch and a training reference image patch; and
training the machine learning model to predict an alignment index between the training inspection image patch and the training reference image patch.
26. A non-transitory computer readable medium that stores a set of instructions that is executable by at least on processor of a computing device to cause the computing device to perform a method for correcting distortion of an inspection image, the method comprising:
acquiring an inspection image;
determining local alignment results for a plurality of patches of the inspection image based on a reference image corresponding to the inspection image;
estimating a first alignment model based on a first subset of the local alignment results and estimating a second alignment model based on a second subset of the local alignment results;
evaluating the first alignment model based on a fit of the first alignment model to a first remainder set of the local alignment results and evaluating the second alignment model based on a fit of the second alignment model to a second remainder set of the local alignment results;
selecting one of the first alignment model and the second alignment model based on the evaluations; and
correcting a distortion of the inspection image based on the selected alignment model.
27. The computer readable medium of clause 26, wherein, in evaluating the first alignment model, the set of instructions that is executable by at least one processor of the computing device cause the computing device to further perform:
determining, in the first remainder set of the local alignment results, a percentage of local alignment results that fit the first alignment model.
28. The computer readable medium of clause 26 or 27, wherein the first subset and the second subset are randomly selected.
29. The computer readable medium of any one of clauses 26-28, wherein the set of instructions that is executable by at least one processor of the computing device cause the computing device to further perform:
aligning the plurality of patches of the inspection image based on the reference image; and
evaluating, by a machine learning model, an alignment between a first patch of the plurality of patches and a corresponding patch of the reference image.
30. The computer readable medium of clause 29, wherein the set of instructions that is executable by at least one processor of the computing device cause the computing device to further perform:
acquiring a training inspection image patch and a training reference image patch; and
training the machine learning model to predict an alignment index between the training inspection image patch and the training reference image patch.
31. A method for correcting distortion of an inspection image, comprising:
acquiring an inspection image;
aligning a plurality of patches of the inspection image based on a reference image corresponding to the inspection image;
evaluating, by a machine learning model, alignments between each patch of the plurality of patches and a corresponding patch of the reference image;
determining local alignment results for the plurality of patches of the inspection image based on a reference image corresponding to the inspection image;
determining an alignment model based on the local alignment results; and correcting a distortion of the inspection image based on the alignment model.
32. The method of clause 31, further comprising:
realigning the plurality of patches of the inspection image based on evaluations of the alignments.
33. The method of clause 31 or 32, wherein the plurality of subsets are randomly selected.
34. The method of any of clauses 31-33, further comprising:
acquiring a training inspection image patch and a training reference image patch; and
training the machine learning model to predict an alignment index between the training inspection image patch and the training reference image patch.
35. The method of any of clauses 31-34, wherein determining the alignment model comprises:
for each subset of the plurality of subsets of the local alignment results:
determining an alignment model based on the subset of the local alignment results, and
evaluating the alignment model based on a fit of the alignment model to a remainder set of the local alignment results; and
selecting one alignment model among the plurality of alignment models based on the evaluations of the alignment models.
36. An apparatus for correcting distortion of an inspection image, comprising:
a memory storing a set of instructions; and
at least one processor configured to execute the set of instructions to cause the apparatus to perform:
acquiring an inspection image;
aligning a plurality of patches of the inspection image based on a reference image corresponding to the inspection image;
evaluating, by a machine learning model, alignments between each patch of the plurality of patches and a corresponding patch of the reference image;
determining local alignment results for the plurality of patches of the inspection image based on a reference image corresponding to the inspection image;
determining an alignment model based on the local alignment results; and
correcting a distortion of the inspection image based on the alignment model.
37. The apparatus of clause 36, wherein the at least one processor is configured to execute the set of instructions to cause the apparatus to further perform:
realigning the plurality of patches of the inspection image based on evaluations of the alignments.
38. The apparatus of clause 36 or 37, wherein the plurality of subsets are randomly selected.
39. The apparatus of any of clauses 36-38, wherein the at least one processor is configured to execute the set of instructions to cause the apparatus to further perform:
acquiring a training inspection image patch and a training reference image patch; and
training the machine learning model to predict an alignment index between the training inspection image patch and the training reference image patch.
40. The apparatus of any of clauses 36-39, wherein, in determining the alignment model, the at least one processor is configured to execute the set of instructions to cause the apparatus to further perform:
for each subset of the plurality of subsets of the local alignment results:
determining an alignment model based on the subset of the local alignment results, and
evaluating the alignment model based on a fit of the alignment model to a remainder set of the local alignment results; and
selecting one alignment model among the plurality of alignment models based on the evaluations of the alignment models.
41. A non-transitory computer readable medium that stores a set of instructions that is executable by at least on processor of a computing device to cause the computing device to perform a method for correcting distortion of an inspection image, the method comprising:
acquiring an inspection image;
aligning a plurality of patches of the inspection image based on a reference image corresponding to the inspection image;
evaluating, by a machine learning model, alignments between each patch of the plurality of patches and a corresponding patch of the reference image;
determining local alignment results for the plurality of patches of the inspection image based on a reference image corresponding to the inspection image;
determining an alignment model based on the local alignment results; and
correcting a distortion of the inspection image based on the alignment model.
42. The computer readable medium of clause 41, wherein the set of instructions that is executable by at least one processor of the computing device cause the computing device to further perform:
realigning the plurality of patches of the inspection image based on evaluations of the alignments.
43. The computer readable medium of clause 41 or 42, wherein the plurality of subsets are randomly selected.
44. The computer readable medium of any of clauses 41-43, wherein the set of instructions that is executable by at least one processor of the computing device cause the computing device to further perform:
acquiring a training inspection image patch and a training reference image patch; and
training the machine learning model to predict an alignment index between the training inspection image patch and the training reference image patch.
45. The computer readable medium of any of clauses 41-44, wherein, in determining the alignment model, the set of instructions that is executable by at least one processor of the computing device cause the computing device to further perform:
for each subset of the plurality of subsets of the local alignment results:
determining an alignment model based on the subset of the local alignment results, and
evaluating the alignment model based on a fit of the alignment model to a remainder set of the local alignment results; and
selecting one alignment model among the plurality of alignment models based on the evaluations of the alignment models.
46. A method of evaluating alignment of an inspection image and a reference image, comprising:
acquiring a plurality of patches of the inspection image and a plurality of reference patches of the reference image, the plurality of patches corresponding to the plurality of reference patches; and evaluating, by a machine learning model, an alignment of the plurality of patches and the plurality of reference patches.
47. The method of clause 46, wherein evaluating, by the machine learning model, the alignment comprises:
evaluating an alignment of a first patch of the plurality of patches and a first reference patch of the plurality of reference patches; and
generating an alignment index representing a degree of confidence that the first patch is aligned to the first reference patch.
48. The method of clause 46, wherein evaluating, by the machine learning model, the alignment comprises:
evaluating an alignment of each pair of the plurality of patches and the plurality of reference patches; and
generating, for the each pair, an alignment index representing a degree of confidence that the each pair is aligned.
49. The method of any one of clauses 46-48, further comprising:
acquiring a training inspection image patch and a training reference image patch; and
training the machine learning model to predict an alignment index between the training inspection image patch and the training reference image patch.
50. The method of clause 49, wherein acquiring the pair of the training inspection image patch and the training reference image patch comprises:
acquiring information whether the training inspection image patch and the training reference image patch is aligned or not.
51. An apparatus of evaluating alignment of an inspection image and a reference image, the apparatus comprising:
a memory storing a set of instructions; and
at least one processor configured to execute the set of instructions to cause the apparatus to perform:
acquiring a plurality of patches of the inspection image and a plurality of reference patches of the reference image, the plurality of patches corresponding to the plurality of reference patches; and
evaluating, by a machine learning model, an alignment of the plurality of patches and the plurality of reference patches.
52. The apparatus of clause 51, wherein, in evaluating, by the machine learning model, the alignment, the at least one processor is configured to execute the set of instructions to cause the apparatus to further perform:
evaluating an alignment of a first patch of the plurality of patches and a first reference patch of the plurality of reference patches; and
generating an alignment index representing a degree of confidence that the first patch is aligned to the first reference patch.
53. The apparatus of clause 51, wherein, in evaluating, by the machine learning model, the alignment, the at least one processor is configured to execute the set of instructions to cause the apparatus to further perform:
evaluating an alignment of each pair of the plurality of patches and the plurality of reference patches; and
generating, for the each pair, an alignment index representing a degree of confidence that the each pair is aligned.
54. The apparatus of any one of clauses 51-53, wherein the at least one processor is configured to execute the set of instructions to cause the apparatus to further perform:
acquiring a training inspection image patch and a training reference image patch; and
training the machine learning model to predict an alignment index between the training inspection image patch and the training reference image patch.
55. The apparatus of clause 54, wherein, in acquiring the pair of the training inspection image patch and the training reference image patch, the at least one processor is configured to execute the set of instructions to cause the apparatus to further perform:
acquiring information whether the training inspection image patch and the training reference image patch is aligned or not.
56. A non-transitory computer readable medium that stores a set of instructions that is executable by at least on processor of a computing device to cause the computing device to perform a method of evaluating alignment of an inspection image and a reference image, the method comprising:
acquiring a plurality of patches of the inspection image and a plurality of reference patches of the reference image, the plurality of patches corresponding to the plurality of reference patches; and
evaluating, by a machine learning model, an alignment of the plurality of patches and the plurality of reference patches.
57. The computer readable medium of clause 56, wherein, in evaluating, by the machine learning model, the alignment, the set of instructions that is executable by at least one processor of the computing device cause the computing device to further perform:
evaluating an alignment of a first patch of the plurality of patches and a first reference patch of the plurality of reference patches; and
generating an alignment index representing a degree of confidence that the first patch is aligned to the first reference patch.
58. The computer readable medium of clause 56, wherein, in evaluating, by the machine learning model, the alignment, the set of instructions that is executable by at least one processor of the computing device cause the computing device to further perform:
evaluating an alignment of each pair of the plurality of patches and the plurality of reference patches; and
generating, for the each pair, an alignment index representing a degree of confidence that the each pair is aligned.
59. The computer readable medium of any one of clauses 56-58, wherein the set of instructions that is executable by at least one processor of the computing device cause the computing device to further perform:
acquiring a training inspection image patch and a training reference image patch; and
training the machine learning model to predict an alignment index between the training inspection image patch and the training reference image patch.
60. The computer readable medium of clause 59, wherein, in acquiring the pair of the training inspection image patch and the training reference image patch, the set of instructions that is executable by at least one processor of the computing device cause the computing device to further perform:
acquiring information whether the training inspection image patch and the training reference image patch is aligned or not.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for correcting distortion of an inspection image, comprising:
acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.

2. The method of claim 1, wherein evaluating the alignment model comprises:
determining, in the remainder set of the local alignment results, a percentage of local alignment results that fit the alignment model.

3. The method of claim 1, wherein the plurality of subsets are randomly selected.

4. The method of claim 1, further comprising:
aligning the plurality of patches of the inspection image based on the reference image; and
evaluating, by a machine learning model, an alignment between a first patch of the plurality of patches and a corresponding patch of the reference image.

5. The method of claim 4, further comprising:
acquiring a training inspection image patch and a training reference image patch; and
training the machine learning model to predict an alignment index between the training inspection image patch and the training reference image patch.

6. An apparatus for correcting distortion of an inspection image, the apparatus comprising:
a memory storing a set of instructions; and
at least one processor configured to execute the set of instructions to cause the apparatus to perform:
acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.

7. The apparatus of claim 6, wherein, in evaluating the alignment model, the at least one processor is configured to execute the set of instructions to cause the apparatus to further perform:
determining, in the remainder set of the local alignment results, a percentage of local alignment results that fit the alignment model.

8. The apparatus of claim 6, wherein the plurality of subsets are randomly selected.

9. The apparatus of claim 6, wherein the at least one processor is configured to execute the set of instructions to cause the apparatus to further perform:
aligning the plurality of patches of the inspection image based on the reference image; and
evaluating, by a machine learning model, an alignment between a first patch of the plurality of patches and a corresponding patch of the reference image.

10. The apparatus of claim 9, wherein the at least one processor is configured to execute the set of instructions to cause the apparatus to further perform:
acquiring a training inspection image patch and a training reference image patch; and
training the machine learning model to predict an alignment index between the training inspection image patch and the training reference image patch.

11. A non-transitory computer readable medium that stores a set of instructions that is executable by at least on processor of a computing device to cause the computing device to perform a method for correcting distortion of an inspection image, the method comprising:
acquiring an inspection image;
determining local alignment results for a plurality of patches of the inspection image based on a reference image corresponding to the inspection image;
for each subset of a plurality of subsets of the local alignment results:
determining an alignment model based on the subset of the local alignment results, and
evaluating the alignment model based on a fit of the alignment model to a remainder set of the local alignment results;
selecting one alignment model among the plurality of alignment models based on the evaluations; and
correcting a distortion of the inspection image based on the selected alignment model.

12. The computer readable medium of claim 11, wherein, in evaluating the alignment model, the set of instructions that is executable by at least one processor of the computing device cause the computing device to further perform:
determining, in the remainder set of the local alignment results, a percentage of local alignment results that fit the alignment model.

13. The computer readable medium of claim 11, wherein the plurality of subsets are randomly selected.

14. The computer readable medium of claim 11, wherein the set of instructions that is executable by at least one processor of the computing device cause the computing device to further perform:
aligning the plurality of patches of the inspection image based on the reference image; and
evaluating, by a machine learning model, an alignment between a first patch of the plurality of patches and a corresponding patch of the reference image.

15. The computer readable medium of claim 14, wherein the set of instructions that is executable by at least one processor of the computing device cause the computing device to further perform:
acquiring a training inspection image patch and a training reference image patch; and
training the machine learning model to predict an alignment index between the training inspection image patch and the training reference image patch.

16. The method of claim 1, further comprising:
estimating a first alignment model based on a first subset of the local alignment results and estimating a second alignment model based on a second subset of the local alignment results.

17. The method of claim 16, further comprising:
evaluating the first alignment model based on a fit of the first alignment model to a first remainder set of the local alignment results and evaluating the second alignment model based on a fit of the second alignment model to a second remainder set of the local alignment results.

18. The apparatus of claim 6, wherein the at least one processor is configured to execute the set of instructions to cause the apparatus to further perform:
estimating a first alignment model based on a first subset of the local alignment results and estimating a second alignment model based on a second subset of the local alignment results.

19. The apparatus of claim 18, wherein the at least one processor is configured to execute the set of instructions to cause the apparatus to further perform:
evaluating the first alignment model based on a fit of the first alignment model to a first remainder set of the local alignment results and evaluating the second alignment model based on a fit of the second alignment model to a second remainder set of the local alignment results.

20. The computer readable medium of claim 15, wherein the set of instructions that is executable by at least one processor of the computing device cause the computing device to further perform:
estimating a first alignment model based on a first subset of the local alignment results and estimating a second alignment model based on a second subset of the local alignment results; and
evaluating the first alignment model based on a fit of the first alignment model to a first remainder set of the local alignment results and evaluating the second alignment model based on a fit of the second alignment model to a second remainder set of the local alignment results.
